(19) United States
(12) Patent Application Publication
(10) Pub. No.: US 2020/0180505 A1
(43) Pub. Date: Jun. 11, 2020

(54) Distress Flash Alert Toggle Switch

(71) Applicant: Kylah Marshae Green, Alpharetta, GA (US)

(72) Inventor: Kylah Marshae Green, Alpharetta, GA (US)

(21) Appl. No.: 16/214,137

(22) Filed: Dec. 10, 2018

(51) Int. Cl. B60Q 1/52; H01H 23/12

(52) U.S. Cl. CPC B60Q 1/52; H01H 23/12

(57) ABSTRACT

My invention calls for a completely different Hazard Light System (Separate from the standard hazard lights in vehicles today), to be installed on the front and rear of the vehicle and upon request on the both sides of the vehicle. For maximum security, the activation button/toggle switch should be installed in multiple places within the interior of the car, preferably in inconspicuous places known only to the owner of the vehicle. The lighting system and the activation button should be prewired to the battery source. Please see drawings #10 & #11 that illustrates the wiring process for the Distress Flash Toggle switch.

### CROSS REFERENCE TO RELATED APPLICATIONS

#29/613,631

### STATEMENT REGARDING FEDERALLY SPONSORED RESEARCH OR DEVELOPMENT

Not Applicable

### SPECIFICATIONS

### Background of Invention

My invention's Field of Endeavor pertains to the Automobile Manufacturing Industry. To my knowledge there is no other product in the Automobile Manufacturing process that will offer the same security that my invention will provide to drivers. The standard Hazard lights that are on automobiles today are not being utilized for the same purpose as my invention will be used for. The standard hazard lights are basically recognized as a device used when a car is disabled, or a vehicle is pulling a large load and wants to alert the surrounding drivers not to follow too closely. I live in the Metro area of Atlanta, Ga. where I have seen and heard about multiple carjackings, murders, kidnappings etc. Numerous times I have read on seen on the news, incidents of people being kidnapped and Amber Alerts going out, people being carjacked and forced to drive to the bank to withdraw money, people having medical emergencies and dying on the road, or just people who have been taken against their will. Many times when drivers have their hazard lights on, people tend to think they are having car problems or they are driving slowly because they are pulling a load, when in fact they could be in medical distress and/or a victim of kidnapping. Most people just ignore the lights and continue on their paths. Maybe they may be thinking that the driver of the disable car has already called someone for help. If my invention were put on the market and drivers were driving behind or in front of a vehicle that had the “Distress Flash Alert” activated, they would more than likely call “911” and copy the license plate number and description of the vehicle if they were to see this distinctive alert. Therefore, possibly saving a life. It could also alert law enforcement to approach with extreme caution.

### BRIEF SUMMARY OF THE INVENTION

My Invention is a two-part invention where one cannot work without the other being connected simultaneously.

The general idea of my invention is to simply save lives by providing an extra piece of equipment that will alert drivers that something other than a disabled vehicle is happening. By installing my “Distress Flash Alert and Distress Flash Alert Toggle Switch” in vehicles, this can provide the extra help that may be needed in cases where someone may be in imminent danger.

### DETAILED DESCRIPTION OF THE INVENTION

Part 1 (Please Refer to Design Patent)

My invention calls for a completely different Hazard Light System (Separate from the standard hazard lights in vehicles today), to be installed on the front and rear of the vehicle and upon request on the both sides of the vehicle. For maximum security, the activation button/toggle switch should be installed in multiple places within the interior of the car, preferably in inconspicuous places known only to the owner of the vehicle. The lighting system and the activation button should be prewired to the battery source.

The LCD lighting board will be installed perhaps on the exterior of the rear trunk or somewhere near the license plate and in the front of the vehicle somewhere near the headlights.

The lights will be placed within the casing in such a position that will spell out HELP. The LED lights will have a distinctive color perhaps black. The flashing illuminating lights will flash semi-rapidly when activated while spelling out the word “HELP. This will alert other drivers or even law enforcement that a person is in serious distress such as a kidnapping, or a medical related emergency and not just a possible disabled vehicle if it were parked on the side of the road. This will also alert law enforcement to approach the vehicle with extreme caution. It will also eliminate the need for a person perhaps being kidnapped to say something that might further endanger their life.

The police will already know that there is a serious problem regardless of what the driver may say or forced to say by their abductors. The person in distress will push the “Distress Flash Alert” button on the control panel that is hidden on the interior of the vehicle. (See drawings 5, 6, 7 & 8) and is easily accessible, but located in an inconspicuous location known only to the vehicle's owner. This will alert drivers in back of them and in front of them that they are in imminent danger or need emergency medical attention and need help right away.

Part 2 (Distress Flash Alert Toggle Switch)

How to Install this Device

The first thing you should do is locate the place where the lighting system will be mounted and also make sure that your wiring will be long enough for the installation. You will need to run both the main power wire (with in-line fuse attached) and earth wire from your light system or light kit directly to the car battery.

How to Wire a Toggle Switch

To operate your lights manually, you will need an activation/toggle switch that will be located somewhere near you but in an inconspicuous location. You will need a simple 2-way toggle” switch (or you can use the switch that may have come with your led kit). This switch will be inserted into (in-line with) the main power wire that supplies the kit/light system with the 12 Volt power. You will need to cut this power wire for the lighting system or kit (make sure you have positioned all of the components in their proper locations and are sure the wires are long enough) and then join each end of the power wires you just cut into each side of the toggle switch. This will allow you to switch the lights on & off separate from a direct power source. Now that you have joined the switch into the power wire of the light kit, you'll now need to run a “fuse-protected” power wire from the battery going to the switch. The fuse should be no more than 18 inches away from the positive terminal on the battery. You may need to solder the fuse to the power wire for your lights, or the fuse may have already come complete in the light kit. If you need to solder any wires together, be sure to use heat shrink to cover your soldered connection (put heat shrink on first before you solder wires together). Once you have soldered the wires together, then “smear” a small amount of silicone over the joint, then slid your heat shrink over the joint and “heat-up” with a cigarette lighter until the heat shrink tubing “shrinks tight” around the soldered joint. This will hold the wires together tightly.

You will need to run this power wire through one of the “existing holes” in the firewall of your car to reach the battery. This is the wall that separates the interior of the car from the engine compartment. If you will be drilling holes in the firewall, make sure you insert a rubber grommet so that the metal will not rub the wires bare.

Note: For any vehicle project that involves drilling holes into the body, first check where you're going to drill the holes to be sure you don't make a mistake and puncture or damage any critical parts such as brake lines, fuel lines and electrical lines, etc., you can view the holes from under the hood or under the dashboard of the vehicle. To complete the “electrical circuit”—you need to attach the earth wire from your led to the negative ground earth of the chassis. You can be done in two ways:

1) Attach it anywhere where there is bare steel under the dash is always a good earth connection, even if you find a screw under the dash that is already screwed into bare steel that is holding another wire in place as an earth, you can use this too as an earth location. Or . . .

2) You can run the earth wire along the same path as the power wire going straight to the “negative” side of the car battery, this is most likely the easiest and surest way of doing it. After your “power” & “earth” connections are complete, your led lights should now work through the switch you installed. You are accessing 12 volts of power directly from the car battery on its own circuit.

1) I Kylah Marshae Green claim the The “Distress Flash Alert” activation toggle button that controls the activation of the flashing lights that spell out the word “HELP” when activated by the toggle switch. (This button, when activated must not be heard from inside the vehicle when activated). This lighting board can be made in any shape but must spell out the word :HELP”.

2) I claim that the lighting system that is referenced in my Design patent application #29/613,631 must and can only be used with the Distress Flash Alert Toggle Switch referenced in this Utility patent application.

3) I claim that the lighting system can be made in any shape but, I claim that the words must be spelled out to say “HELP” or any other word or acronym such as SOS related/referencing “Help” or “Distress” and that the toggle switch must be connected to the lighting system in order for the lighting board to work and be activated.
